(19) United States
(12) Patent Application Publication
(10) Pub. No.: US 2009/0229184 A1
(43) Pub. Date: Sep. 17, 2009

(54) DOOR DERAILING PREVENTION MEMBER INSTALLATION STRUCTURE FOR ELEVATOR

(76) Inventors: Arai Hideki, Chiba (JP); Toi Takashi, Chiba (JP); Hideki Itoh, Chiba (JP)

Correspondence Address: CARLSON GASKEY & OLDS, 400 W MAPLE STE 350, BIRMINGHAM, MI, 48009, US

(21) Appl. No.: 12/294,547

(22) PCT Filed: Mar. 14, 2007
(86) PCT No.: PCT/US07/06393

§ 371 Date: Sep. 25, 2008

(30) Foreign Application Priority Data
Mar. 31, 2006 (JP) 2006 096245

(51) Int. Cl. E06B 7/00; F16B 37/00

(52) U.S. Cl. 49/70; 411/427

(57) ABSTRACT

Exemplary embodiments of the invention include a door derailing prevention member having a body with a middle section and a circumferential surface. An installation stud is positioned at the middle section and a boss part is mounted to the body and is configured to mate with a hole and secure the body in a fixed position. The body has a radius that varies along the circumferential surface.

### BACKGROUND SECTION

The present invention pertains to a structure for installing a door derailing prevention member used to prevent a sliding door of an elevator from derailing from a door rail.

As described in Japanese Patent Application No. 2000-26053, for example, an elevator sliding door is hung from a door rail via a door hanger equipped with hanger rollers and up-thrust rollers, and the sliding door opens/closes the doorway of the elevator along the door rail as the aforementioned hanger rollers travel on the door rail. On the other hand, the up-thrust rollers are provided such that they approach the door rail from below, and they function as door derailing prevention members, that is, the up-thrust rollers come into contact with the door rail when the hanger rollers are lifted from

Conventionally, an up-thrust roller has been used for this purpose, wherein a roller is provided on a pedestal equipped with a slotted and threaded stud while its center of rotation is off-center with respect to the axial center of the threaded stud. The aforementioned up-thrust roller is fixed to the door hanger at a prescribed distance from the door rail using the aforementioned threaded stud and a nut.

Here, when the gap between the aforementioned up-thrust roller and the door rail is to be adjusted, the aforementioned nut is tightened with a wrench to tentatively attach the up-thrust roller to the door hanger, and the aforementioned installation stud is rotated by means of a screwdriver using the aforementioned slot in order to adjust the gap between the aforementioned roller and the door rail appropriately. The nut is then tightened further using the wrench while using the screwdriver to prevent the aforementioned installation stud from rotating in order to secure the up-thrust roller to the door hanger.

In the case of the aforementioned conventional up-thrust roller, because the aforementioned installation stud is fixed at its center in order to prevent it from rotating when attaching the up-thrust roller to the door hanger after the aforementioned gap is adjusted, it is difficult to completely prevent the aforementioned installation stud from rotating, and there is the risk that the aforementioned gap may change if the aforementioned installation stud also rotates when the nut is tightened. Therefore, this method is not desirable in that it becomes necessary to adjust the roller installation position by taking the amount the installation stud may rotate when the nut is tightened into consideration, and the operation becomes cumbersome.

In addition, it is not desirable in terms of strength because the aforementioned roller is essentially cantilevered and the aforementioned pedestal is positioned between the aforementioned roller and the door hanger so that, a heavy load is applied to the aforementioned installation stud when the aforementioned roller is pressed against the door rail.

### SUMMARY OF THE INVENTION

Exemplary embodiments of the invention include a door derailing prevention member having a body with a middle section and a circumferential surface. An installation stud is positioned at the middle section and a boss part is mounted to the body and is configured to mate with a hole and secure the body in a fixed position. The body has a radius that varies along the circumferential surface.

### BRIEF DESCRIPTION OF THE DRAWINGS

FIG. 1 is a diagram showing a first embodiment of the present invention, wherein an oblique view of a sliding door which opens/closes the doorway of an elevator is shown.

FIG. 2 is an oblique view of the derailing prevention member in FIG. 1 when it is disassembled.

FIG. 3 is a front view of the derailing prevention member in FIG. 2.

FIG. 4 is a diagram showing the relative positions between the derailing prevention member and the door rail when the position in which the boss part and the installation hole are engaged is changed in stages in the rotational direction.

FIG. 5 is a diagram showing a second embodiment of the present invention, wherein an oblique view of a derailing prevention member is shown.

FIG. 6 is a diagram showing a modified example of the positioning protrusion and positioning hole shown in FIG. 5.

### DETAILED DESCRIPTION

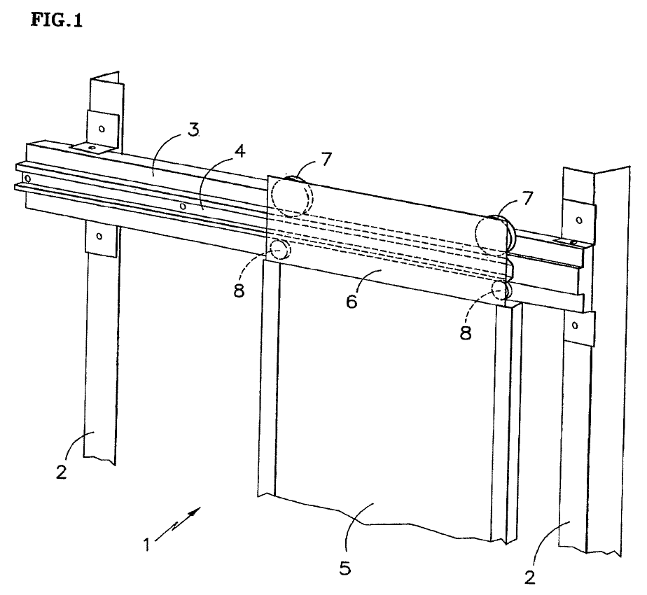

FIG. 1 is an oblique view of a sliding door which opens/closes the elevator doorway in a specific embodiment of the present invention.

As shown in FIG. 1, elevator doorway 1 is formed between facing vertical frames 2, and said vertical frames 2 are connected together at the top using header 3. Header 3 is equipped with door rail 4 which is provided running along the longitudinal direction, and sliding door 5 is hung from and supported by said door rail 4, with sliding door 5 being guided by door rail 4 to open/close doorway 1. Furthermore, although doorway 1 is opened/closed using multiple sliding doors 5, they are omitted in the illustration since each sliding door 5 has the same structure and is hung from door rail 4.

More specifically, nearly flat plate-like door hanger 6 is installed between sliding door 5 and door rail 4, and door hanger 6 is integrally connected with sliding door 5. Hanger rollers 7, which can rotate freely, are provided on the right-hand side and the left-hand side of said door hanger 6, and said hanger rollers 7 move by rotating on door rail 4 while they are engaged with door rail 4.

In addition, a door derailing prevention member 8 is located on door hanger 6 so as to face hanger rollers 7. In this way, door rail 4 is sandwiched from above and below by hanger rollers 7 and derailing prevention member 8, and a minute gap is formed between derailing prevention member 8 and door rail 4. Therefore, when hanger rollers 7 are lifted from door rail 4, that is, when door hanger 6 is lifted from door rail 4, the circumferential surfaces of derailing prevention member 8 functioning as contact surfaces come into contact with door rail 4 to prevent lifted sliding door 5 from derailing.

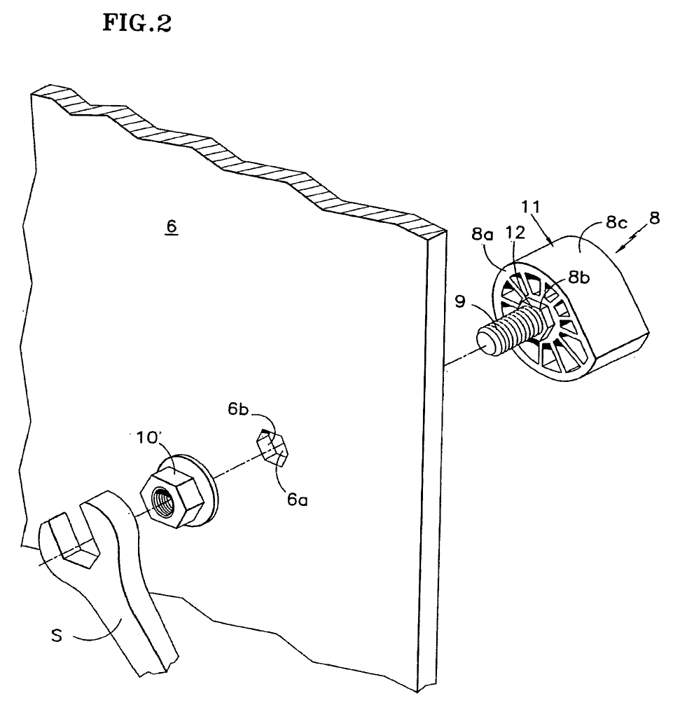

FIG. 2 is an oblique view of derailing prevention member 8 in FIG. 1 when it is disassembled.

As shown in FIG. 2, derailing prevention member 8 has a body 11 in which an installation stud 9 projects from a pedestal surface 8a. The installation stud 9 is located at a middle section 12 of the body 11. The material of the body 11 includes a hard resin, metal, and rubber. The installation stud 9 is fitted by insertion and integrally fixed with derailing prevention member 8, while equilateral hexagonal boss part 8b, which protrudes from pedestal surface 8a, is formed concentrically with installation stud 9. Furthermore, male threads, are formed on the circumferential surface of installation stud 9.

In addition, an installation hole 6a, which is used also as a positioning hole, is created in door hanger 6. The installation hole 6a is hexagonal, just like boss part 8b, and one of the flat inner wall surfaces 6b which constitute said installation hole 6a is formed parallel with the bottom surface of door rail 4. It is noted that installation hole 6a can be any polygon shape, so long as it matches boss part 8b.

Installation hole 6a and boss part 8b can be engaged with and disengaged from each other, and the rotational position around installation shaft 9 in which boss part 8b and installation hole 6a are engaged can be adjusted in stages. In this way, after boss part 8b is fitted into installation hole 6a by inserting installation stud 9 into installation hole 6a so as to seat pedestal surface 8a against door hanger 6, derailing prevention member 8 is fixed to door hanger 6 using installation stud 9 and nut 10 serving as the threaded member to be screwed to it. In other words, although the position in which derailing prevention member 8 is installed on door hanger 6, that is, the rotational position around installation stud 9 in which derailing prevention member 8 is installed, is determined as boss part 8b is fitted into installation hole 6a, the rotational position in which derailing prevention member 8 is installed can be adjusted in stages, 60° at a time, by selectively changing the relative position between said boss part 8b and installation hole 6a in the rotational direction.

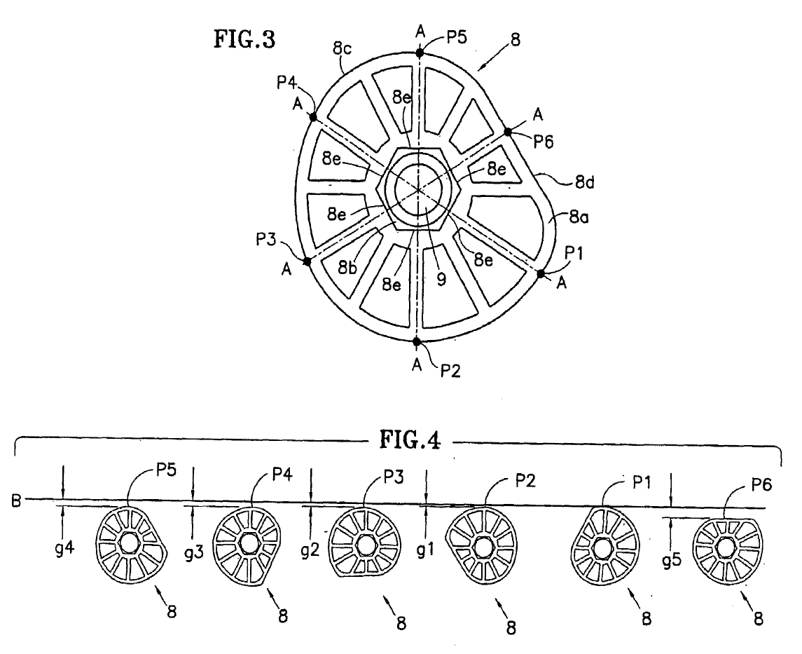

FIG. 3 is a front view of derailing prevention member 8, and FIG. 4 is a diagram showing the relative positions between derailing prevention member 8 and door rail 4 when the position where boss part 8b and installation hole 6a are engaged is changed in stages in the rotational direction.

As is clear from FIG. 3, decentered cam-like derailing prevention member 8 is formed to have an essentially cam-like cross section, such that the distance between its circumferential surface 8c itself and installation stud 9 changes gradually in the rotational direction around installation stud 9 along nearly the entire perimeter of said circumferential surface 8c; and the cross section of circumferential surface 8c is formed as a spiral line as represented by an involute curve, for example, and part of it includes flat surface 8d.

The positions on circumferential surface 8c obtained by dividing body 11 into six equal parts, at 60° in the circumferential direction, are then set as contact spots P1 through P6, and contact spot P6 is positioned on flat surface 8d. That is, the respective contact spots P1 through P6 are arranged such that their distances from the axial center of installation stud 9 vary, whereby the distances from the axial center of installation stud 9 to respective contact spots P1 through P6 increase or decrease in stages in either the forward rotational direction or reverse rotational direction of body 11. Also, in terms of the relative positions between respective contact spots P1 through P6 on circumferential surface 8c and hexagonal boss part 8b, flat surface 8d on said circumferential surface 8c is set such that it becomes parallel to one of the flat surfaces 8e on boss part 8b. As a result, respective contact spots P1 through P6 are positioned over respective center lines A which bisect respective flat surfaces 8e on boss part 8b, as shown in FIG. 3.

That is, one of flat surfaces 8e of boss part 8b is placed facing and parallel to the bottom surface of door rail 4 when boss part 8b is fitted into installation hole 6a, and one of contact spots P1 through P6 which correspond to said flat surfaces 8e comes into contact with door rail 4 so as to perform the door derailing prevention function in order to prevent hanger roller 7 from being lifted from door rail 4. Here, when the position where boss part 8b is fitted into installation hole 6a is changed in the rotational direction around installation stud 9, the contact spot which executes the door derailing prevention function is also changed, so that the gap between derailing prevention member 8 and door rail 4 is also changed.

For example, in the present embodiment, the cross section of circumferential surface 8c of body 11 is arranged such that the radius is at the maximum at contact spot P1, and the radius is at the minimum at contact spot P6. Furthermore, the radiuses of respective contact spots P2 through P5 other than contact spots P1 and P6 are set such that the radius is reduced in stages from the maximum radius at contact spot P1 toward the minimum radius at contact spot P6 in the clockwise direction in FIG. 3. Then, as shown in FIG. 4 and as described above, because the positions on body 11 where the radiuses at respective contact spots P1 through P6 change in stages are determined at 60° intervals with reference to line B corresponding to the bottom surface of door rail 4 in order for respective contact spots P1 through P6 to be positioned facing line B, the gaps between the respective contact spots P1 through P6 and line B are changed also. In this case, the gaps between them becomes the minimum, that is, zero, when contact spot P1 is placed at the position facing line B, and gaps g1 through g4 between line B and said contact spots P2 through PS are also increased in stages as the contact spot facing line B changes from P2 to P5 in stages. Furthermore, gap g5 becomes the maximum when contact spot P6 is placed at the position facing line B. Thus the cross section of circumferential surface 8c of body 11 is arranged to obtain g1<g2<g3<g4<g5.

During installation of derailing prevention member 8 configured in the aforementioned manner on door hanger 6, even when installation stud 9 is first inserted into installation hole 6a on the door hanger 6 side, installation hole 6a and boss part 8b never engage with each other, body 11 is kept in a condition in which it can rotate with respect to door hanger 6, and flat surface 8d (contact spot P6) of circumferential surface 8c of body 11 is placed face to face with the bottom surface of door rail 4. While the condition in which installation hole 6a and boss part 8b are not engaged continues to be maintained, body 11 is turned in the clockwise direction so as to press a portion of circumferential surface 8c of body 11 against the bottom surface of door rail 4, and the position at which the gap between circumferential surface 8c of body 11 and the bottom surface of door rail 4 becomes essentially zero is determined. (This determined position is referred to as the reference position.)

Once derailing prevention member 8 is placed at the reference position, body 11 is turned slowly in the counterclockwise direction while it is pressed against door hanger 6 in order to find the position where pedestal surface 8a seats on door hanger 6 as installation hole 6a engages with boss part 8b for the first time. The gap created between circumferential surface 8c of body 11 and the bottom surface of door rail 4 is then checked to find if it is appropriate or not. If it is appropriate, nut 10 is tightened onto installation stud 9 from the back side of the door hanger using wrench S in the manner shown in FIG. 2, in order to fix derailing prevention member 8 in said position. The installation of derailing prevention member 8 is now complete.

On the other hand, if the position of engagement between installation hole 6a and boss part 8b creates a gap between circumferential surface 8c of body 11 and the bottom surface of door rail 4 that is not appropriate (too small), the engagement of installation hole 6a with boss part 8b is undone, and body 11 is then turned in the counterclockwise direction while it is pressed against door hanger 6 in the same manner as that described above in order to determine the position where installation hole 6a and boss part 8b engage with each other. As a result, the gap between circumferential surface 8c of body 11 and the bottom surface of door rail 4 becomes greater than before. Whether the gap is appropriate or not is checked, and nut 10 is tightened onto installation stud 9 from the back side of the door hanger in the same manner as was described above in order to fix derailing prevention member 8 in the position. The installation of derailing prevention member 8 is now completed. In addition, if a decision is made that the original gap is more appropriate as a result of checking the gap, body 11 is turned in the clockwise direction by 1 stage in order to restore the previous condition.

Furthermore, in the event that the gap between derailing prevention member 8 and door rail 4 has increased due to wear of the door rail 4 or hanger rollers 7 and needs to be adjusted, nut 10 is loosened using wrench S to undo the engagement of boss part 8b with installation hole 6a and release derailing prevention member 8, the position where boss part 8b should be engaged with installation hole 6a is determined, they are engaged with each other at said engagement position, and derailing prevention member 8 is fixed to door hanger 6 using nut 10.

Therefore, when the installation structure employing derailing prevention member 8 and having the aforementioned configuration is adopted, derailing prevention member 8 cannot rotate relative to door hanger 6 since boss part 8b is engaged with installation hole 6a, so that there is no need to secure derailing prevention member 8 to make it immovable when screwing nut 10 onto installation stud 9, and the installation of derailing prevention member 8 not only becomes easy, but also the maintainability can be improved. Moreover, the fixing work to prevent derailing prevention member 8 from turning is no longer needed when screwing nut 10 onto installation stud 9, so design of the derailing prevention member 8 arrangement becomes flexible.

In addition, because derailing prevention member 8 is seated directly on door hanger 6, the contact areas between derailing prevention member 8 and door hanger 6 are increased, which is advantageous in that the amount of so-called cantilever wherein derailing prevention member 8 project from door hanger 4 is further reduced, the load applied to installation stud 9 when the circumferential surfaces of derailing prevention member 8 are pressed against door rail 4 is reduced to offer an advantage in terms of strength, and spatial efficiency can be improved due to the small amount that derailing prevention member 8 project from door hanger 4.

Furthermore, changes in the gap between derailing prevention member 8 and door rail 4 due to the relative rotation between derailing prevention member 8 and door hanger 6 can be prevented since boss parts 8b are engaged with installation holes 6a, resulting in the advantage that the frequency with which the gap between derailing prevention member 8 and door rail 4 is adjusted can be reduced.

Furthermore, although door rail 4 was designed to be sandwiched between hanger rollers 7 and derailing prevention member 8 in the present embodiment, when a channel-shaped door rail is used, for example, hanger rollers 7 and derailing prevention member 8 can of course be provided inside the “ko”-shape [the shape of a sideways U″].

In addition, although boss part 8b was formed as an equilateral hexagon in the example of the present embodiment, polygonal shapes other than the equilateral hexagons, such as equilateral octagons, the equilateral dodecagons, etc., can of course be adopted for boss part 8b. When boss part 8b is formed as a polygon, flexibility in determining the position of derailing prevention member 8 can be improved.

In addition, as can be understood from the figures, derailing prevention member 8 can include multiple derailing prevention member 8 on one door hangar 6.

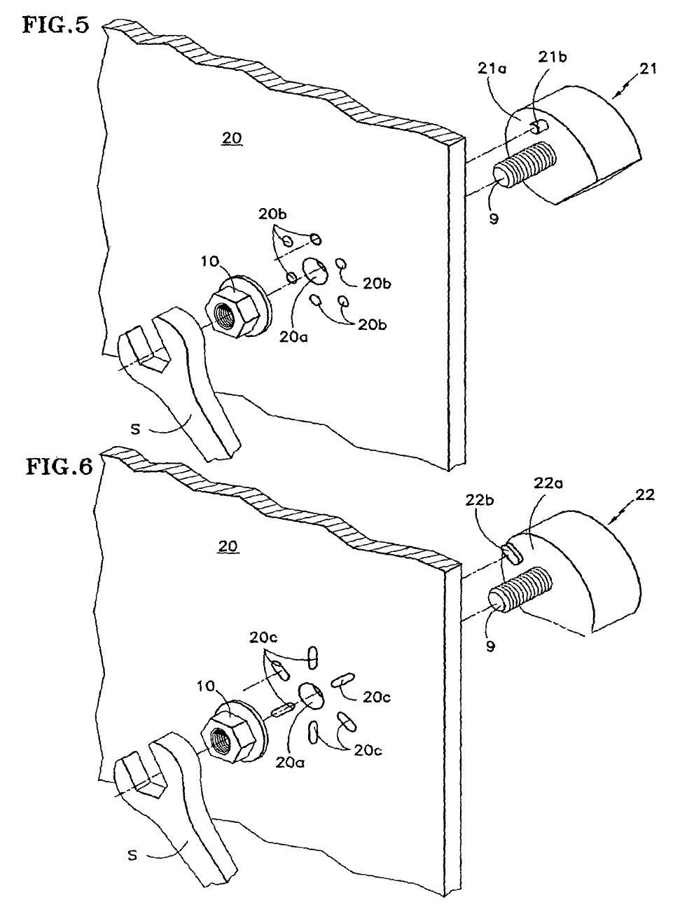

FIG. 5 is an oblique disassembled view of the derailing prevention member of a second embodiment of the present invention.

In the second embodiment shown in FIG. 5, installation hole 20a created in door hanger 20 is circular, multiple positioning holes 20b are created along a concentric circle around the axial center of said installation hole 20a, that is, the axial center of installation stud 9. A boss part 21b, which in this embodiment is formed as a hemispherical positioning protrusion, is created at the position on pedestal surface 21a of derailing prevention member 21 where it corresponds to positioning holes 20b. Here, positioning hole 20b is a round hole and boss part 21b is shaped to match the shape of positioning holes 20b, and boss part 21b can be engaged with and disengaged from positioning holes 20b.

During the installation of derailing prevention member 21 on door hanger 20, the position at which a positioning hole 20b is engaged with boss part 21b is determined in the same manner as in the first embodiment, they are engaged with each other at said engagement position, and derailing prevention member 21 is fixed to door hanger 20 using nut 10.

Therefore, according to derailing prevention member 21 of the second embodiment, an effect similar to that of the first embodiment can be achieved.

FIG. 6 is a diagram showing a modified example of positioning hole 20b and boss part 21b in FIG. 5.

In the modified example shown in FIG. 6, positioning holes 20c are formed as oblong holes, and a boss part 22b is in the shape of a parallel key and formed to protrude from pedestal surface 22a of derailing prevention member 22 and fit into a positioning hole 20c, thereby achieving an effect similar to that of the second embodiment.

Because it is no longer necessary to fix the door derailing prevention member to prevent it from turning when the nut is screwed onto the installation stud because the relative position of the door derailing prevention member with respect to the door hanger is determined when the boss part and the positioning hole are fitted together, not only does the installation of the door derailing prevention member become easy, but also the maintainability of adjustment of the gap between the door derailing prevention member and the door rail can be improved.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A door derailing prevention member comprising:
a body having a middle section and a circumferential surface;
an installation stud positioned at the middle section; and
a boss part that is configured to mate with a hole and secure the body in a fixed position,
wherein the body has a radius that varies along the circumferential surface,
wherein the boss part is configured as a polygon and is formed concentrically with the installation stud and the hole has a corresponding polygon shape; and
wherein the installation stud is received through the hole.

2. The member of claim 1 comprising a nut that mates with the installation stud.

3. The member of claim 2 wherein the installation stud and the nut are threaded.

4. The member of claim 1 wherein the body has a seat pedestal surface and the boss part is disposed at the seat pedestal surface.

5. The member of claim 1 wherein the body is in the shape of a decentered cam, and a cross section of the body includes a spiral line.

6. The member of claim 1 wherein the installation stud is received through an installation hole.

7. The member of claim 6 wherein the installation hole is formed on a door hanger, and the body is installed on the door hanger that is positioned between a sliding door and a door rail of an elevator and is used to support the sliding door by hanging it from the door rail via hanger rollers.

8. A door derailing prevention member comprising:
a body having a middle section and a circumferential surface;
an installation stud positioned at the middle section; and
a boss part that is configured to mate with a hole and secure the body in a fixed position,
wherein the body has a radius that varies along the circumferential surface,
wherein the installation stud is received through an installation hole,
wherein the installation hole includes multiple positioning holes that are formed on the door hanger along a concentric circle around an axial center of the installation hole, and
wherein the boss part is configured to engage with one of the multiple positioning holes.

9. The member of claim 8 wherein the body is in the shape of a decentered cam, and a cross section of the body includes a spiral line.

10. The member of claim 8 comprising a nut that mates with the installation stud.

11. The member of claim 10 wherein the installation stud and the nut are threaded.

12. The member of claim 8 wherein the body has a seat pedestal surface and the boss part is disposed at the seat pedestal surface.

13. The member of claim 8 wherein the installation stud is received through an installation hole.

14. The member of claim 13 wherein the installation hole is formed on a door hanger, and the body is installed on the door hanger that is positioned between a sliding door and a door rail of an elevator and is used to support the sliding door by hanging it from the door rail via hanger rollers.
